(19) United States
(12) Patent Application Publication
(10) Pub. No.: US 2021/0182738 A1
(43) Pub. Date: Jun. 17, 2021

(54) ENSEMBLE MANAGEMENT FOR DIGITAL TWIN CONCEPT DRIFT USING LEARNING PLATFORM

(71) Applicant: GENERAL ELECTRIC COMPANY, Schenectady, NY (US)

(72) Inventors: Paul ARDIS, Niskayuna, NY (US); Andrew Cohen, Niskayuna, NY (US); Weizhong YAN, Clifton Park, NY (US)

(21) Appl. No.: 16/716,685

(22) Filed: Dec. 17, 2019

(51) Int. Cl. G06N 20/20; G06N 5/04

(52) U.S. Cl. CPC G06N 20/20; G05B 13/0265; G06N 5/043

(57) ABSTRACT

Some embodiments provide systems and methods associated with an industrial asset. An ensemble of learners (e.g., base learner models) may comprise a digital twin that corresponds to the industrial asset. A learning agent platform (e.g., associated with reinforcement learning), coupled to the ensemble of learners, may manage the ensemble by receiving information about current operation of the industrial asset. The platform may then apply learning to the received information and generate data that modifies the ensemble of learners (e.g., by adding, pruning, and/or modifying models in the ensemble). In some embodiments, a boosting scheme may be employed to enhance decision making by the learning agent platform (e.g., a learner's voting weight might be inversely proportional to its error on a previous batch of information).

### BACKGROUND

In order to monitor and analyze a physical industrial asset such as a wind turbine, a gas turbine, industrial machinery, healthcare systems, and the like, a virtual asset (e.g., a “digital twin”) may be created of the physical asset. The virtual asset is essentially a digital model of the physical asset. It can be easier and more cost efficient to monitor and analyze a virtual asset rather than the corresponding physical asset because the virtual asset does not require expensive hardware (e.g., sensors) to be installed and does not require data to be acquired from the actual site of the physical asset because such monitoring and analyzing can be performed via a computer system.

However, one of the drawbacks of asset modeling is the occurrence of “concept drift” between the virtual asset and the physical asset which can happen over time. In predictive analytics and machine learning, concept drift refers to unforeseen changes that occur to the physical asset which the virtual asset is trying to predict, and as a result, predictions become less accurate as time goes by and/or opportunities to improve accuracy might be missed. Therefore, the learning model (e.g., the virtual asset) needs to adapt to changes quickly and accurately.

Traditional approaches to resolving concept drift center around the use of heuristics to determine when responding actions to the model should be taken such as model change-out or retraining of the model. Various ensemble methods for managing concept drift rely on one or more heuristics (based on individual model error and overall ensemble error) for adding models, pruning models, an/or updating models and data selection after which the ensemble makes an aggregate decision. The effectiveness of such approaches, however, may depend on modeling assumptions and/or prior knowledge about drift conditions.

It may therefore be desirable to automatically and effectively manage a digital twin ensemble to help reduce the effect of concept drift.

### SUMMARY

Some embodiments provide systems and methods associated with an industrial asset. An ensemble of learners (e.g., base learner models) may comprise a digital twin that corresponds to the industrial asset. A learning agent platform, coupled to the ensemble of learners, may manage the ensemble by receiving information about current operation of the industrial asset. The platform may then apply learning (e.g., reinforcement learning) to the received information and generate data that modifies the ensemble of learners (e.g., by adding, pruning, and/or modifying models in the ensemble). In some embodiments, a boosting scheme may be employed to enhance decision making by the learning agent platform (e.g., a learner's voting weight might be inversely proportional to its error on a previous batch of information).

Some embodiments comprise: means for generating a learning agent to manage an ensemble of learners that comprise a digital twin corresponding to the industrial asset; means for receiving, by the learning agent, information about current operation of the industrial asset; and means for applying learning to the received information to generate data that modifies the ensemble of learners.

Some technical advantages of some embodiments disclosed herein are improved systems and methods associated with an industrial asset that automatically and effectively manage a digital twin ensemble to help reduce the effect of concept drift.

### BRIEF DESCRIPTION OF THE DRAWINGS

FIG. 1 is a high-level block diagram of a system associated with an industrial asset according to some embodiments.

FIG. 2 is an industrial asset protection method in accordance with some embodiments.

FIG. 3 is a reinforcement learning formulation according to some embodiments.

FIG. 4 is a more detailed block diagram of a system in accordance with some embodiments.

FIG. 5 is an example of an algorithm to manage drift according to some embodiments.

FIG. 6 is an ensemble management display in accordance with some embodiments.

FIG. 7 illustrates classifier accuracies according to some embodiments.

FIG. 8 is a block diagram of an industrial asset platform according to some embodiments of the present invention.

FIG. 9 is a tabular portion of an ensemble database in accordance with some embodiments.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

Concept drifts in regression and classification problems have been shown to frustrate static modeling approaches. According to some embodiments described herein, reinforcement learning may be effectively applied to manage ensembles of models, providing needed modeling dynamism. This approach may be demonstrated against industrial data to showcase one potential application in a gas turbine as well as other complex system control domains.

A digital twin of a manufactured industrial asset may be created to reduce maintenance costs and increase revenue (through improved operation and new business models), including critical components in power generation used throughout the world. Model update capabilities are fundamental to maintaining these digital twins as assets age, are damaged, change operation, or are reconfigured, as in many of these cases we are presented with the challenge of concept drift.

One of the key capabilities of modeling real-world systems is the ability to continuously update as new insights become available, even in the presence of changing conditions. To that end, some embodiments may incorporate a framework for this need in the presence of a variety of concept drift conditions while removing modeling assumptions that are fundamental to the effectiveness of the current state-of-the-art.

In supervised learning problems, an important aim is to predict a target variable y∈R^{k} (for regression tasks; y is a label for classification) given a vector of input features x∈R^{x}. Consider, for example a data stream of (x, y) vectors D with |Dₜ|≥1 and Dₜ arrives at time t.

The concept drift problem is formally defined as a change in the conditional distribution of y over time; that is, ∃t∃x: P(y|xₜ)≠P(y|xₜ₊₁). Existing approaches to solving concept drift are typically based upon the use of heuristics to determine when responding action should be taken. Specific actions—such as model change-out or retraining—varies, but ultimately the approach may need an effective trigger to ensure timely response to drift. Note that many of the most effective solutions provide an ability to capture arbitrary drifts through managed ensembles of models across portions of the input timeline.

As with general concept drift, solutions for concept drift that make use of ensembles of learners are typically tied to the use of heuristics for model inclusion/exclusion, ensemble weight adjustment, or both.

The simplest ensemble management approach to concept drift is to maintain two constituent models: a long-duration historical model and a short-duration recent model. A variety of drifts can be captured by this approach. Note that a tradeoff may be associated with thresholded performance of each model alone, and some approaches assume that drift complexity and duration can be handled by just the two models together. When considering arbitrary compositions of arbitrary drifts, then, it may be necessary to consider larger ensembles with more active management.

Some proposed solutions to drifts at varied scale suggest a performance-based persistence of models but use a hard constant number of carried-over constituents and look only at individual performance (rather than ensemble outputs). Other approaches may use variable constituent time scales which can be effective at capturing drifts of varied abruptness but ultimately might be associated with a wipe-all pruning scheme and hard thresholds of ensemble accuracy used for new model inclusion. In both cases, success may hinge upon problem definitions that match with hard model counts—a more flexible approach may require a dynamic selection of ensemble size and/or action scope.

Dynamic reweighting gets closer by allowing for effectively dynamic model drop-out but lacks similar dynamic growth (and is typically stuck with a fixed model set after some initial time point). Furthermore, the embodied policies governing the drop-out may remain static throughout each example regardless of their overall performance. That is, no ability is provided to reconsider inclusion sensitivity. As such, some embodiments described herein may pursue a solution that uses reinforcement learning to allow for data-driven dynamism in constituent model specifics, ensemble size, and/or action triggering.

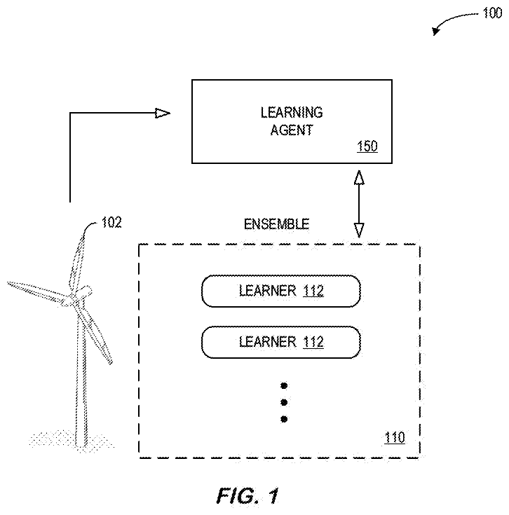

In particular, some embodiments described herein may apply learning to manage ensembles of models to provide needed modeling dynamism. For example, FIG. 1 is a high-level architecture of a system 100 that might be associated with an industrial asset 102 such as a wind turbine. The system 100 may include a digital twin ensemble 110 comprised of a plurality of learners 112. According to some embodiments, a learning agent 150 (e.g., associated with reinforcement learning) may receive information from the industrial asset 102 and automatically manage the ensemble 110 as appropriate to reduce concept drift. As used herein, the terms “automatically” or “autonomous” may refer to, for example, actions that can be performed with little or no human intervention.

As used herein, devices, including those associated with the system 100 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The learning agent 150 may be associated with a platform that stores information into and/or retrieves information from various data stores. The various data sources may be locally stored or reside remote from the learning agent 150. Although a single ensemble 110 and learning agent 150 are shown in FIG. 1, any number of such devices may be included. Moreover, various devices described herein might be combined according to embodiments of the present invention. For example, in some embodiments, the learning agent 150 and an operator or administrator device might comprise a single apparatus. The learning agent 150 might be performed by a constellation of networked apparatuses, in a distributed processing or cloud-based architecture.

An operator or administrator might access the system 100 via a monitoring device (e.g., a Personal Computer (“PC”), tablet, or smartphone) to view information about and/or manage reinforcement learning information in accordance with any of the embodiments described herein. In some cases, an interactive graphical display interface may let a user define and/or adjust certain parameters (e.g., establishing rules or conditions) and/or provide or receive automatically generated recommendations or results from the learning agent 150.

Note that Reinforcement Learning (“RL”) problems may be formulated as a Markov Decision Process (“MDP”). An MDP Mis defined as the 5-tuple (S, A, P, R, γ) where S is a set of states, A is a set of actions, R_{s,s′}^{α}, the immediate reward for performing action a in states and transitioning to s′, P(s′|s,α)∈[0,1] the probability of transitioning to state s′ after performing a ins and γ∈(0, 1) the discount on future rewards. Solutions to a MDP are policies π: s→α which map states to actions. Value iteration based RL algorithms aim to approximate the value function Q_{π} from samples where Q_{π}(s, α) is the expected return of performing a ins and following policy to completion:

$${Q}_{π} ( s , a ) = {E}_{π} [ {\sum }_{i = 0}^{∞} {γ}^{i} {r}_{i + 1} ]$$

The sample collected at time step t+1 is the tuple, (sₜ, αₜ, sₜ₊₁, rₜ₊₁), where at is the action performed in sₜ and rₜ₊₁ is the immediate reward received for transitioning to sₜ₊₁. Particularly, we are interested in the optimal Q-function which is defined as the unique solution to the optimal Bellman equation:

$${Q}^{*} ( s , a ) = {\sum }_{{s}^{′} ∈ S} P ( {s}^{′} \vert s , a ) {R}_{s , {s}^{′}}^{a} + γ {max}_{{α}^{′} ∈ A} {Q}^{*} ( {s}^{′} , {a}^{′} )$$

From this, an optimal policy may be extracted:

π*(s)=armax_{α}Q*(s,α)

Some embodiments described herein pursue this optimal policy via Fitted Q-iteration (“FQI”), an off-policy, batch mode, value iteration based RL algorithm that uses function approximation to deal with continuous state variables.

Each constituent base learner 112 may comprise a trainable model of the input space such that it provides an output prediction with a computable metric of accuracy against known truth. At initiation, the model may be trained based upon a subset of data available up until then, after which its parameters are locked. At each time point thereafter, the model may be applied to predict a value corresponding to the current time step's vector of (input) observations; hysteresis may be considered “out of bounds” for the base learner. Taken together, the set of base learners 112 at any time t forms the ensemble 110.

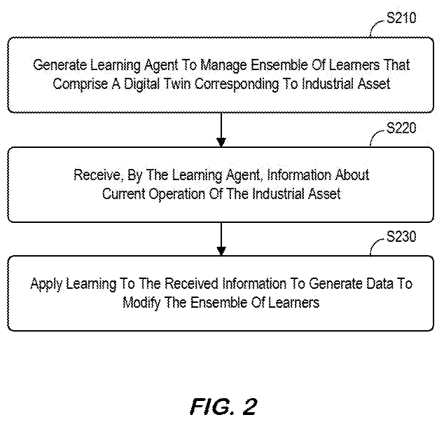

FIG. 2 is an industrial asset protection method that might be associated with the elements of the system of FIG. 1. Note that the flowcharts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, a learning agent (e.g., associated with reinforcement learning) may be generated to manage an ensemble of learners that comprise a digital twin corresponding to an “industrial asset.” As used herein, the phrase “industrial asset” might refer to, for example, a turbine (e.g., a gas or wind turbine), an engine, (e.g., a jet or locomotive engine), a refinery, a power grid, a dam, an autonomous vehicle, etc.

At S220, the learning agent may receive information about current operation of the industrial asset. At S230, the system may apply learning to the received information to generate data that modifies the ensemble of learners. The modification of the ensemble of learners might include, for example, adding a model, pruning a model, and/or modifying a model. According to some embodiments, the learning is associated with reinforcement learning (based on a MDP) and the learning agent platform employs a boosting scheme to enhance decision making by the learning agent. For example, the boosting scheme might use a learner's voting weight is inversely proportional to its error on a previous batch of information. In some embodiments, an aggregate decision of the ensemble is associated with a weighted average in a regression approach. In other embodiments, the aggregate decision of the ensemble is instead associated with a weighted vote in a classification approach. Note that the learning agent platform may make control decisions based on statistics describing the performance of the ensemble and the learners. Moreover, the statistics may include information about a tunable heuristic in performance space independent of any specific task and drift.

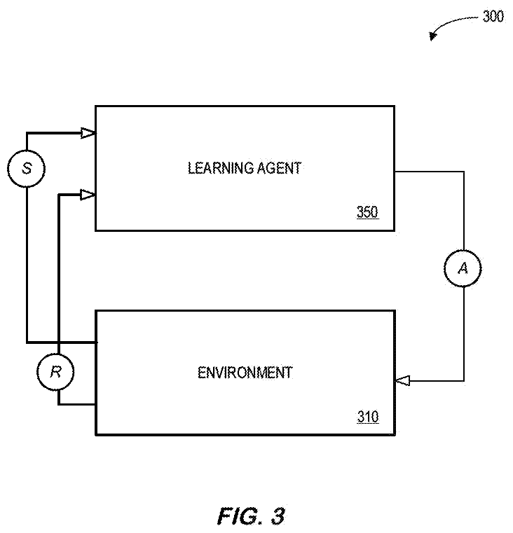

FIG. 3 is a learning formulation 300 (e.g., associated with reinforcement learning) that includes an environment 310 and a learning agent 350 according to some embodiments. In this formulation 300, S is associate with a trend of ensemble's performance and/or size of the ensemble, A is associated with adding or pruning a model (or both), and R is a parameter indicating if the system is outside of an acceptable performance range, inside the range, entering or leaving range (e.g. {−1, 1, 0}). With respect to learning a prune action, S may be associated with a trend of a model's performance and/or trend of the ensemble's performance, A might indicate that a model should be included or excluded, and R might represent an accuracy gain or loss on the most recently available labeled record.

Some ensemble methods for managing concept drift may rely on one or more heuristics (based on individual model error and overall ensemble error) for adding models, pruning models, updating models, and data selection after which the ensemble makes an aggregate decision. Instead of specifying heuristics, some embodiments described herein let an RL agent learn a management policy for an ensemble. That is, the system may let an agent make control decisions based on statistics that describe the performance trends of the ensemble and constituents. Formally, the MDP may be formulated as follows:
S=[Average ensemble error on last k batches,
   Number of models in ensemble]
A∈{Add model trained on the most recent data chunk Dᵢ,
   Prune model(s) from ensemble,
   Both Add and Prune actions}
R∈{Outside of acceptable performance range (r<0),
   Inside acceptable performance range (r>0),
   Crossing performance boundary (r=0)}

Reward R is proportional to the ensemble classification error's distance to 0% and the parity depends on the boundary r of “acceptable performance.” While this boundary itself might be considered a (tunable) heuristic, it is a heuristic in the performance space independent of any specific task and drift. The boundary r introduces additional structure to the learning task by identifying subtasks: (1) get to a performance range and (2) maintain performance in that range with encouragement to move toward 0% classification error. Additionally, it serves to make the agent's interactions with the data stream episodic, which allows segments of experience (trajectories) to be collected and learned from in an online fashion as opposed to the in finite horizon case (where it may not be clear when to add a sequence of experiences to the agent's historical data for learning).

The question of which model or how many models to prune from the ensemble is not trivial and, like higher level ensemble management, embodiments described herein may answer that question without using task-specific thresholds. Therefore, the above formulation may be augmented such that the prune action is itself learned over the following MDP:
S=[Model j's error Eⱼᵢ on most recent batch Dᵢ,
   Average ensemble error on last k batches,
   Ensemble size]
Aϵ{Retain model j in the ensemble,
   Remove model j from the ensemble}
R=Mean delta performance

Learning for concept drift, then, may performed by first learning policies for the pruning agent and then for the management agent. The pruning subproblem may, in some embodiments, train an RL agent to include or exclude the contribution of each individual model from a fixed set of models in the ensemble's aggregate decision, and the formulation may allow for a dynamic set of constituents (as needed for arbitrary concept drift) rather than assuming a priori completeness.

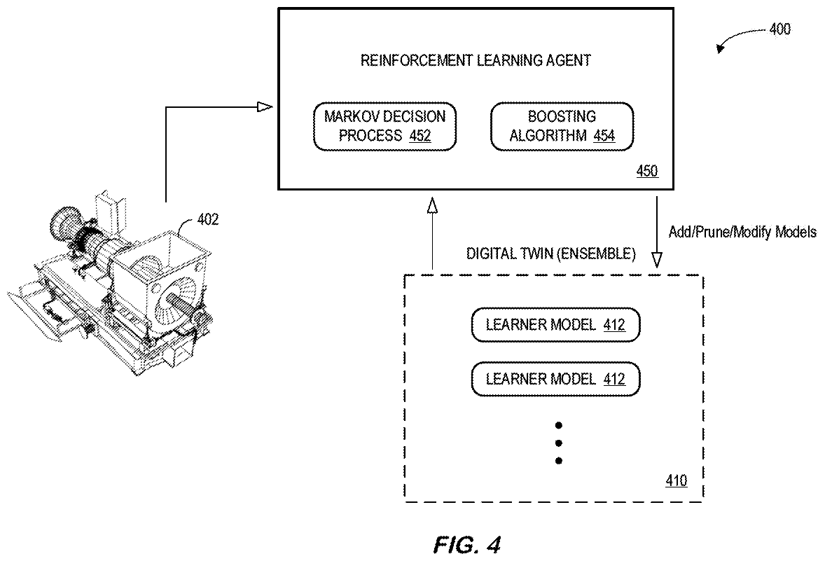

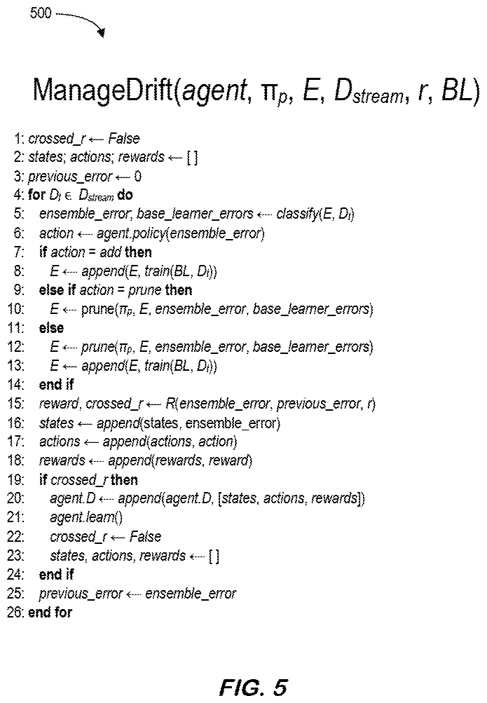

FIG. 4 is a more detailed block diagram of a system 400 in accordance with some embodiments. As before, the system 400 may be associated with an industrial asset 402 such as a gas turbine. The system 400 may include a digital twin ensemble 410 comprised of a plurality of base learner models 412. According to some embodiments, a Reinforcement Learning (“RL”) agent 450 may receive information from the industrial asset 402 and automatically manage the ensemble 410 as appropriate to reduce concept drift. The RL agent 450 may implement a MDP 452 and/or a boosting algorithm 454. Note that in addition to the control of the RL agent 400, embodiments may employ a basic ensemble boosting scheme wherein a base learner's voting weight is inversely proportional to its error on the previous batch of data. The ensemble's aggregate decision may be the weighted average (regression) or weighted vote (classification) of the base learner's estimates. The specifics of this formulation involve a novel application of RL and may simplify the approach to isolate the impact of the reinforcement learner. Algorithm pseudocode 500 for ManageDrift(agent, πp, E, Dstream, r, BL) according to some embodiments is provided in FIG. 5. Note that, according to some embodiments, an automatic learning process (e.g., associated with machine learning) may dynamically evaluate a cost of a particular ensemble action (as opposed to relying on known fixed cost metrics for particular ensemble actions). As a result, the learning may inform a choice or adjustment of ensemble action (and/or modify any associated cost function associated with an optimization).

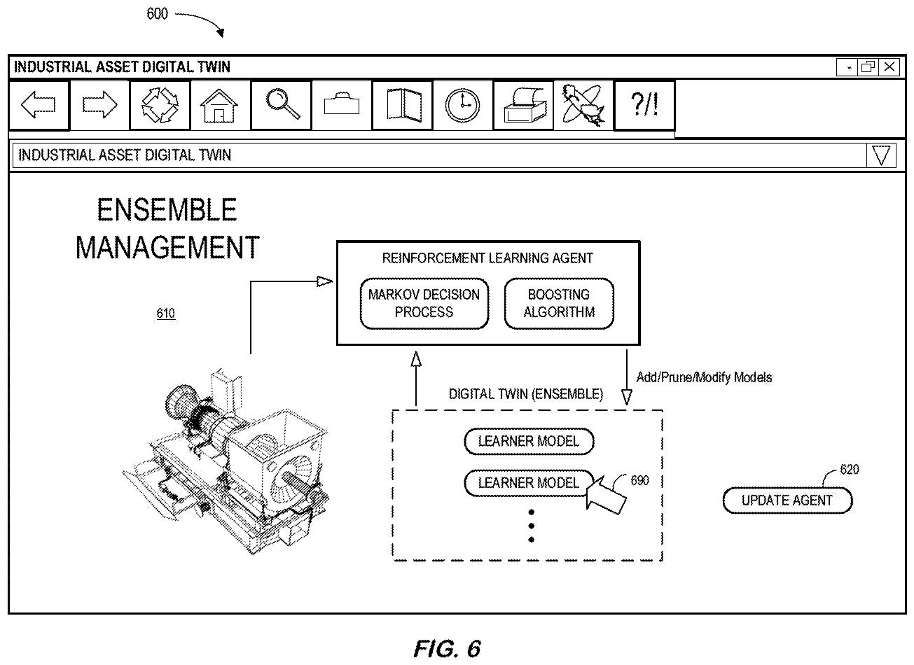

In some cases, an interactive graphical display interface may let a user define and/or adjust certain parameters (e.g., establishing rules or conditions) and/or provide or receive automatically generated recommendations or results from the RL agent 450. FIG. 6 is an example of an ensemble management display 600 that might be used, for example, to provide a graphical representation 610 of the system to an operator and/or to provide an interactive interface allowing the operator to adjust the system as appropriate. Selection of an element on the display 600 (e.g., via a touchscreen or computer mouse pointer 690) might, for example, result in the presentation of more information about that element (e.g., via a popup window), allow an operator to adjust parameters associated with the element, etc. Selection of an “Update Agent” icon 620 might, for example, let an administrator may a RL agent to an industrial asset and/or an ensemble, etc.

Empirical studies may be based upon the use of Extreme Learning Machines (“ELMs”) as base learners, and the ensemble may consist of single-layer feedforward neural networks whose activation functions and hidden layer biases are randomly selected but whose output weights are optimized post-selection. ELMs have seen extensive use in a variety of regression and classification problems and may serve as a proxy for a variety of fixed-order models used in bootstrap aggregation ensemble as well as general modeling entitlement given universal approximation and expressibility of ELMs.

Dataset generation for a digital twin might focus on injecting two types of concept drift—abrupt and gradual—at random initiation points in usage scripts that were fit to a real asset's operation. Operation examples might be generated with 0 or 1 gradual drift present and up to 2 abrupt drifts. Each concept drift may be applied via uniform sampling between 0% and 20% pointwise divergence (via generation efficiency parameter adjustment) with gradual drift duration allowed to span between 50% and 100% of each operation example. Gaussian multiplicative factors (1.0 mean, 0.1 standard deviation) may then be applied pointwise to simulate operational and sensor noise and to increase predictive difficulty. Each resulting dataset may contain 500 unrelated operation examples, each of which contains at least 2000 time series points. Effective performance across this data might suggest an ability to actively predict and optimize the asset under excessively difficult (beyond realistic) conditions in addition to stress-testing general algorithmic performance.

Learned policies prioritize ensemble growth when the classification error is low and trending downwards, attempting to produce a more nuanced set of models to target any remaining performance improvement. Conversely, sudden growth in misclassification triggers aggressive ensemble pruning and rebuilding. This approach may allow for high accuracy tracking for a variety of concept drifts and smoothly handles segments exhibiting multiple drift types.

Additional experiments may be performed using two standard community datasets: Streaming Ensemble Algorithm (“SEA”) and Rotating Hyperplanes. The SEA dataset consists of four subsets, each of which consists of 60,000 points covering four different random concepts that are based upon thresholding of summed feature subsets with 10% class noise. The Rotating Hyperplanes dataset consists of nine subsets, each of which consists of data generated by a simulated time-varying (fixed epoch) moving hyperplane in 2 to 8 dimensions with 5% class noise. Experiments against these datasets may be performed to ensure a fair analysis when compared to existing methods in the literature and to showcase the difficulty of real-world industry entitlement experiments against purely synthetic problems.

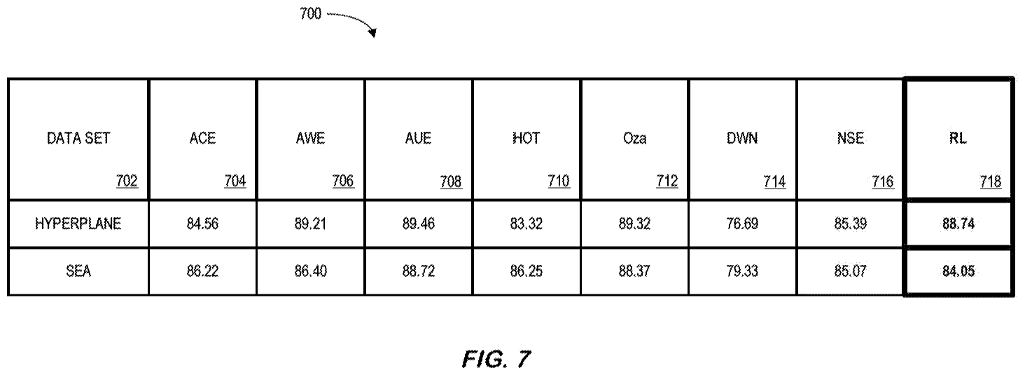

FIG. 7 illustrates classifier accuracies 700 for both data sets 702 according to some embodiments. The algorithms contained in the table 700 are:
Adaptive Classifier Ensemble (“ACE”) 704,
Accuracy Weighted Ensemble (“AWE”) 706,
Accuracy Updated Ensemble (“AUE”) 708,
Heoffding Option Tree (“HOT”) 710,
Online Bagging (“Oza”) 712,
Dynamic Weighted Majority (“DWM”) 714,
Learn++.NSE (“NSE”) 716, and
Reinforcement Learning (“RL”) 718 in accordance with any of the embodiments described herein.

RL 718 may provide comparable results with the other approaches while eschewing the use of problem-specific heuristics, weighting schemes, or base learner selections. As such, the RL approach 718 may increase flexibility without requiring prior knowledge about drift conditions.

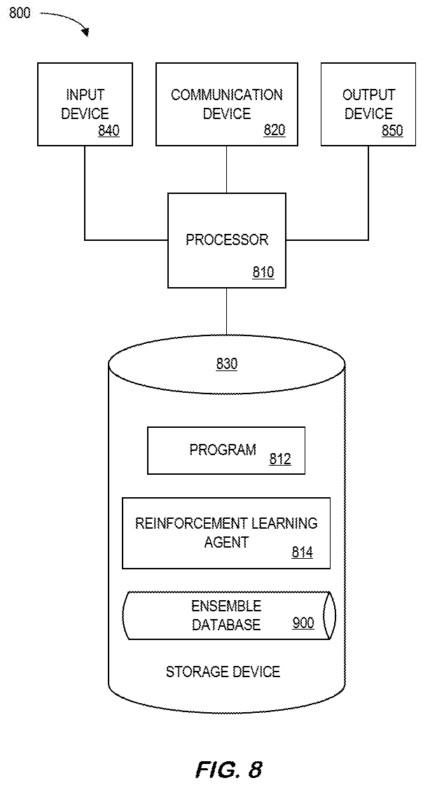

The embodiments described herein may be implemented using any number of different hardware configurations. For example, FIG. 8 is a block diagram of an industrial asset platform 800 that may be, for example, associated with the systems 100, 400 of FIGS. 1 and 4 respectively. The industrial asset platform 800 comprises a processor 810, such as one or more commercially available Central Processing Units (“CPUs”) in the form of one-chip microprocessors, coupled to a communication device 820 configured to communicate via a communication network (not shown in FIG. 8). The communication device 820 may be used to communicate, for example, with one or more remote monitoring nodes, user platforms, digital twins, etc. The industrial asset platform 800 further includes an input device 840 (e.g., a computer mouse and/or keyboard to input learner model information and/or industrial asset information) and/an output device 850 (e.g., a computer monitor to render a display, provide alerts, transmit recommendations, and/or create reports). According to some embodiments, a mobile device, monitoring physical system, and/or PC may be used to exchange information with the industrial asset platform 800.

The processor 810 also communicates with a storage device 830. The storage device 830 may comprise any appropriate information storage device, including combinations of magnetic storage devices (e.g., a hard disk drive), optical storage devices, mobile telephones, and/or semiconductor memory devices. The storage device 830 stores a program 812 and/or a RL agent 814 for controlling the processor 810. The processor 810 performs instructions of the programs 812, 814, and thereby operates in accordance with any of the embodiments described herein. For example, the processor 810 may manage the ensemble by receiving information about current operation of the industrial asset. The processor 810 may then apply learning (e.g., reinforcement learning) to the received information and generate data that modifies an ensemble of learners (e.g., by adding, pruning, and/or modifying models in the ensemble). In some embodiments, a boosting scheme may be employed by the processor 810 to enhance decision making by the RL agent 814 (e.g., a learner's voting weight might be inversely proportional to its error on a previous batch of information).

The programs 812, 814 may be stored in a compressed, uncompiled and/or encrypted format. The programs 812, 814 may furthermore include other program elements, such as an operating system, clipboard application, a database management system, and/or device drivers used by the processor 810 to interface with peripheral devices.

As used herein, information may be “received” by or “transmitted” to, for example: (i) the industrial asset platform 800 from another device; or (ii) a software application or module within the industrial asset platform 800 from another software application, module, or any other source.

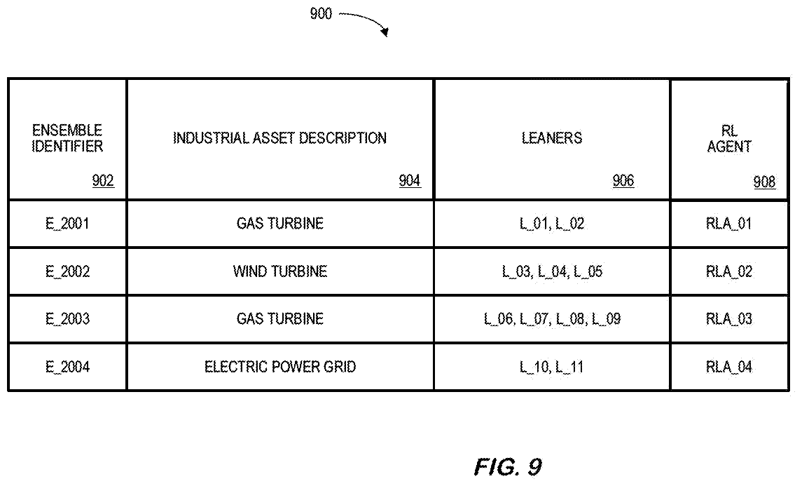

In some embodiments (such as the one shown in FIG. 8), the storage device 830 further stores an ensemble database 900. An example of a database that may be used in connection with the industrial asset platform 800 will now be described in detail with respect to FIG. 9. Note that the database described herein is only one example, and additional and/or different information may be stored therein. Moreover, various databases might be split or combined in accordance with any of the embodiments described herein.

Referring to FIG. 9, a table is shown that represents the ensemble database 900 that may be stored at the industrial asset platform 800 according to some embodiments. The table may include, for example, entries identifying industrial assets being twinned. The table may also define fields 902, 904, 906, 908 for each of the entries. The fields 902, 904, 906, 908 may, according to some embodiments, specify: an ensemble identifier 902, an industrial asset description 904, learners 906, and RL agent 908. The ensemble database 900 may be created and updated, for example, when a new physical system is monitored or modeled, learners 906 are added or deleted, etc.

The ensemble identifier 902 and industrial asset description 904 may comprise alphanumeric strings that identify a digital twin ensemble and associated physical system. The learners 906 may define the base learner models that make up the ensemble. The RL agent 908 may identify the platform or program that monitors the ensemble and updates the learners 906 as appropriate to improve performance of the digital twin model.

Thus, embodiments may provide improved systems and methods associated with an industrial asset that automatically and effectively manage a digital twin ensemble to help reduce the effect of concept drift. Moreover, such an approach may reduce maintenance costs and increase revenue (through improved operation and new business models). Model update capabilities may also be provided or digital twins as assets age, are damaged, change operation, or are reconfigured. Embodiments may provide effective model management tools that can accurately update digital twins in situations typical for industrial assets.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the databases described herein may be combined or stored in external systems). For example, although some embodiments are focused on gas turbine generators, any of the embodiments described herein could be applied to other types of assets, such as dams, the power grid, autonomous vehicles, military devices, etc.

According to some embodiments, no prior knowledge about drift conditions is available. According to other embodiments, similar approaches may be taken with respect to other situations. For example, when prior knowledge about drift conditional is available, that data might be integrated into any of the embodiments described herein to improve digital twin performance.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

1. A system associated with an industrial asset, comprising:
an ensemble of learners that comprise a digital twin corresponding to the industrial asset; and
a learning agent platform, coupled to the ensemble of learners, to manage the ensemble, including:
a computer processor, and
a computer memory storing instructions that, when executed by the computer processor cause the learning agent platform to:
receive information about current operation of the industrial asset, and
apply learning to the received information to generate data that modifies the ensemble of learners.

2. The system of claim 1, wherein the learning agent platform is associated with reinforcement learning.

3. The method of claim 2, wherein the reinforcement learning is based on a Markov Decision Process (“MDP”).

4. The system of claim 1, wherein the learning agent platform is further to:
employ a boosting scheme to enhance decision making by the learning agent.

4. The system of claim 3, wherein the boosting scheme uses a learner's voting weight that is inversely proportional to its error on a previous batch of information.

5. The system of claim 4, when an aggregate decision of the ensemble is associated with one of: (i) a weighted average in a regression approach, or (ii) a weighted vote in a classification approach.

6. The system of claim 1, wherein the modification of the ensemble of learners includes at least one of: (i) adding a model, (ii) pruning a model, and (iii) modifying a model.

7. The system of claim 1, wherein the learning agent platform makes control decisions based on statistics describing the performance of the ensemble and the learners.

8. The system of claim 7, wherein the statistics include information about a tunable heuristic in performance space independent of any specific task and drift.

9. The system of claim 1, wherein the industrial asset is associated with at least one of: (i) a turbine, (ii) a gas turbine, (iii) a wind turbine, (iv) an engine, (v) a jet engine, (vi) a locomotive engine, (vii) a refinery, (viii) a power grid, (ix) a dam, and (x) an autonomous vehicle.

10. A computerized method associated with an industrial asset, comprising:
generating a learning agent to manage an ensemble of learners that comprise a digital twin corresponding to the industrial asset;
receiving, by the learning agent, information about current operation of the industrial asset; and
applying learning to the received information to generate data that modifies the ensemble of learners.

11. The method of claim 10, wherein the applied learning is reinforcement learning based on a Markov Decision Process (“MDP”).

12. The method of claim 10, further comprising:
employing a boosting scheme to enhance decision making by the learning agent.

13. The method of claim 12, wherein the boosting scheme uses a learner's voting weight that is inversely proportional to its error on a previous batch of information.

14. The method of claim 13, when an aggregate decision of the ensemble is associated with one of: (i) a weighted average in a regression approach, or (ii) a weighted vote in a classification approach.

15. The method of claim 10, wherein the modification of the ensemble of learners includes at least one of: (i) adding a model, (ii) pruning a model, and (iii) modifying a model.

16. The method of claim 10, wherein the learning agent platform makes control decisions based on statistics describing the performance of the ensemble and the learners.

17. The system of claim 16, wherein the statistics include information about a tunable heuristic in performance space independent of any specific task and drift.

18. A non-transitory, computer-readable medium storing instructions that, when executed by a computer processor, cause the computer processor to perform a method associated with an industrial asset, the method comprising:
generating a learning agent to manage an ensemble of learners that comprise a digital twin corresponding to the industrial asset;
receiving, by the learning agent, information about current operation of the industrial asset; and
applying learning to the received information to generate data that modifies the ensemble of learners.

19. The medium of claim 18, wherein the applied learning is reinforcement learning based on a Markov Decision Process (“MDP”).

20. The medium of claim 18, wherein the method further comprises:
employing a boosting scheme to enhance decision making by the learning agent.

21. The medium of claim 18, wherein the industrial asset is associated with at least one of: (i) a turbine, (ii) a gas turbine, (iii) a wind turbine, (iv) an engine, (v) a jet engine, (vi) a locomotive engine, (vii) a refinery, (viii) a power grid, (ix) a dam, and (x) an autonomous vehicle.
